(19) United States
(12) Patent Application Publication
(10) Pub. No.: US 2019/0386333 A1
(43) Pub. Date: Dec. 19, 2019

(54) LITHIUM ION SECONDARY BATTERY

(71) Applicant: Ming-Tung SHEN, Taipei City (TW)

(72) Inventors: Ming-Tung SHEN, Taipei City (TW); Meng-Wei SHEN, Taipei City (TW)

(21) Appl. No.: 16/059,186

(22) Filed: Aug. 9, 2018

(30) Foreign Application Priority Data
Jun. 15, 2018 (TW) 107121052

(51) Int. Cl. H01M 10/052; H01M 10/0587; H01M 2/30; H01M 2/02; H01M 4/02

(52) U.S. Cl. CPC H01M 10/052; H01M 10/0587; H01M 2/30; H01G 11/04; H01M 4/02; H01M 2004/027; H01M 2004/028; H01M 2/022

(57) ABSTRACT

A lithium ion secondary battery includes a battery casing, an electrode set reeled inside the battery casing and having a positive electrode and a negative electrode, a positive electrode terminal exposed from a top end of the battery casing and connected to the positive electrode and a negative electrode terminal located at a bottom end of the battery casing and connected to the negative electrode, the lithium ion secondary battery further includes: a super capacitor substrate, disposed in the battery casing and extended between two distal ends of the battery casing, and includes a substrate, a first copper foil connected to the positive electrode terminal, a second copper foil connected to the negative electrode terminal, and at least one capacitor connected to the first copper foil and the second copper foil; and an electrolyte, suitable to be applied in the lithium ion secondary battery.

### BACKGROUND OF THE INVENTION

### 1. Field of the Invention

The present invention relates to a secondary battery, especially to a lithium ion secondary battery.

### 2. Description of Related Art

A lithium ion secondary battery is commonly adopted in a commercial electronic product, for example a mobile phone, a tablet computer and a notebook computer. The lithium ion secondary battery can also be applied in other fields, for example being applied in a military filed, an electric vehicle field and an aviation field.

However, a conventional lithium ion secondary battery still has some safety issues to be solved; when being applied in an electric vehicle, a plurality of lithium ion secondary batteries are connected in series and/or in parallel for forming as a module, because the voltage, the current and the internal resistance of each battery are not the same, the whole performance may be affected while the batteries being connected in series and/or in parallel for forming as the above-mentioned module.

### SUMMARY OF THE INVENTION

One technical feature of the present invention is to provide a lithium ion secondary battery, which includes: a battery casing, an electrode set, reeled inside the battery casing and having a positive electrode and a negative electrode, a positive electrode terminal, exposed from a top end of the battery casing and electrically connected to the positive electrode of the electrode set, and a negative electrode terminal, located at a bottom end of the battery casing and electrically connected to the negative electrode of the electrode set; the lithium ion secondary battery further includes: a super capacitor substrate, disposed in the battery casing and extended between two distal ends of the battery casing, and including a substrate, a first copper foil electrically connected to the positive electrode terminal of the battery via a first metal sheet, a second copper foil electrically connected to the negative electrode terminal of the battery via a second metal sheet, and at least one capacitor electrically connected to the first copper foil and the second copper foil; and an electrolyte suitable to be applied in the lithium ion secondary battery; with the super capacitor substrate, the battery is protected from being damaged by a reflux current/voltage, and a power factor of a load can be increased when the battery is driving the load. To be specific, when the battery is used for charging/discharging, the capacitor will perform a micro charging/discharging operation in a high speed on a surface of the positive electrode and a surface of the negative electrode, so as to prevent formation of lithium dendrites, and prevent a reflux situation of the battery, and thereby prolong a service life of the battery.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view illustrating the lithium ion secondary battery according to one preferred embodiment of the present invention;

FIG. 2 is a schematic view illustrating a super capacitor substrate of the lithium ion secondary battery according to the preferred embodiment of the present invention;

FIG. 3 is a schematic view illustrating the lithium ion secondary battery according to another preferred embodiment of the present invention;

FIG. 4A to FIG. 4C are schematic views illustrating the lithium ion secondary battery according to one another preferred embodiment of the present invention;

FIG. 5 is a schematic view illustrating the lithium ion secondary battery according to still one another preferred embodiment of the present invention;

FIG. 6 is a schematic view illustrating the lithium ion secondary battery according to still one another preferred embodiment of the present invention;

FIG. 7 is a schematic view illustrating the lithium ion secondary battery according to still one another preferred embodiment of the present invention;

FIG. 8 is a schematic view illustrating the lithium ion secondary battery according to still one another preferred embodiment of the present invention; and

FIG. 9 is a schematic view illustrating the lithium ion secondary battery according to still one another preferred embodiment of the present invention.

### DETAILED DESCRIPTION OF THE PREFERRED EMBODIMENT

It is to be understood that for providing a clear illustration, components shown in figures may not be presented with any specified ratio. For example, some components are enlarged relative to other components for the purpose of emphasizing the features of the present invention.

In the provided embodiments, many details are disclosed for allowing the present invention to be comprehensively understood. However, the skilled people in the art shall be able to practice the present invention without the provided details. In other situations, prior arts, for example some methods, processes and components which are well understood by the skilled people in the art, are not disclosed in details for the purpose of providing a clear illustration for the characteristics and features of the present invention.

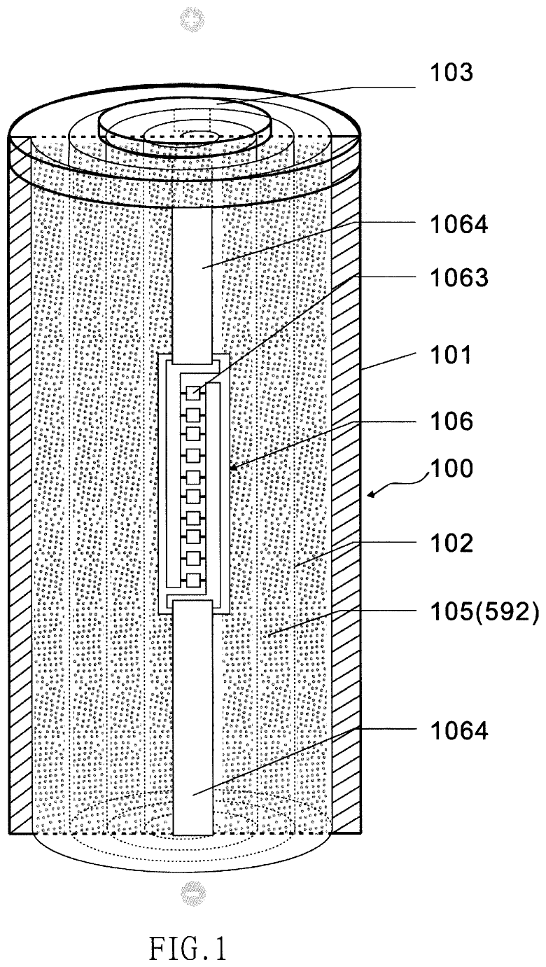

Please refer to FIG. 1, which is a schematic view illustrating the lithium ion secondary battery according to one preferred embodiment of the present invention. The present invention provides a lithium ion secondary battery 100. According to this embodiment, an 18650 battery is adopted as an example for illustrating the lithium ion secondary battery 100. What shall be addressed is that the lithium ion secondary battery 100 can be a soft-packed battery, a 22650 battery, a 40135 battery or other lithium ion secondary batteries with different appearances and dimensions. The lithium ion secondary battery 100 includes a battery casing 101, an electrode set 102 reeled inside the battery casing 101 and having a positive electrode (not shown in figures) and a negative electrode (not shown in figures) (Because the electrode set 102 is a prior air, therefore no further illustration is provided), a positive electrode terminal 103 exposed from a top end of the battery casing 101 and electrically connected to the positive electrode of the electrode set 102, a negative electrode terminal 104 located at a bottom end of the battery casing 101 and electrically connected to the negative electrode of the electrode set 102, a super capacitor substrate 106 disposed at a center of the electrode set 102, and an electrolyte 105 suitable to be applied in the lithium ion secondary battery. For example, the electrolyte 105 can be a lithium salt mixed agent. The electrolyte can also be a solid-state electrolyte, for example a polymer electrolyte. What shall be addressed is that, according to this embodiment, the electrolyte 105 is provided with sodium chloride with a weight ratio from 1% to 99%, so that when the secondary battery provided by the present invention is used in an environment under zero degree Celsius, the electrolyte can be prevented from being frozen so as to ensure a normal operating status of the battery, and the battery can also be protected from exploding and burning while being thrust.

Or, the electrolyte can be an organic or inorganic nano carbon tetrafluoride which is capable of preventing water molecules to be crystalized to generate an freezing effect, in other words an anti-freezing material 592 capable of keeping the electrolyte to be in a liquid status is added in the electrolyte 105, so that the battery can still be used in an embodiment of minus 60 degrees Celsius and has 60% of the original capacity. What shall be addressed is that the anti-freezing material 592 can be any suitable material, as long as the electrolyte can be kept in the liquid status.

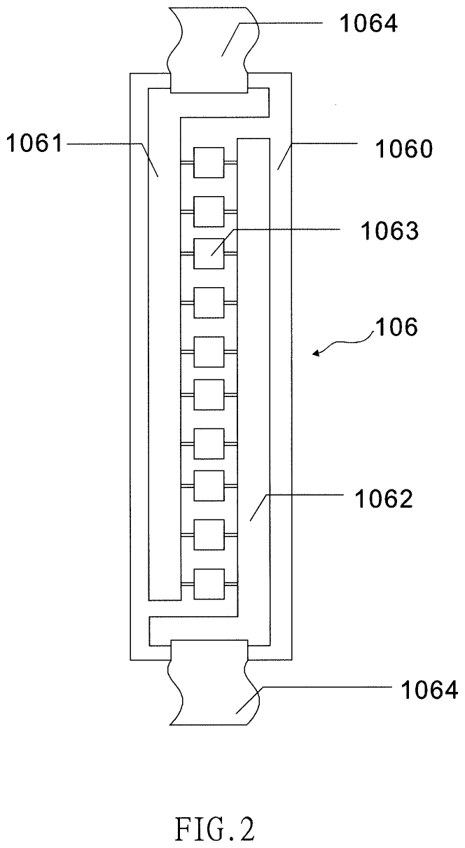

Please refer to FIG. 2; as shown in FIG. 2, the super capacitor substrate 106 includes a substrate 1060, a first copper foil 1061 electrically connected to the positive electrode terminal 103 (as shown in FIG. 1) of the battery via a metal sheet (a first metal sheet) 1064 or any other suitable means, a second copper foil 1062 electrically connected to the negative electrode terminal 104 of the battery via another metal sheet (a second metal sheet) 1064 or any other suitable means, and at least one capacitor 1063 electrically connected to the first copper foil 1061 and the second copper foil 1062. According to this embodiment, the capacitor substrate 106 includes a plurality of capacitors 1063. As shown in FIG. 1, the super capacitor substrate 106 is disposed at a center of the battery casing 101 and extended between two distal ends of the battery casing 101, so as to prevent a reflux current/voltage from damaging the battery, and increase a power factor of a load when the battery is driving the load. When the battery is used for charging/discharging, the super capacitor will perform a micro charging/discharging operation in a high speed on a surface of the positive electrode and a surface of the negative electrode, so as to prevent formation of lithium dendrites, and prevent a reflux situation of the battery, and thereby prolong the service life of the battery.

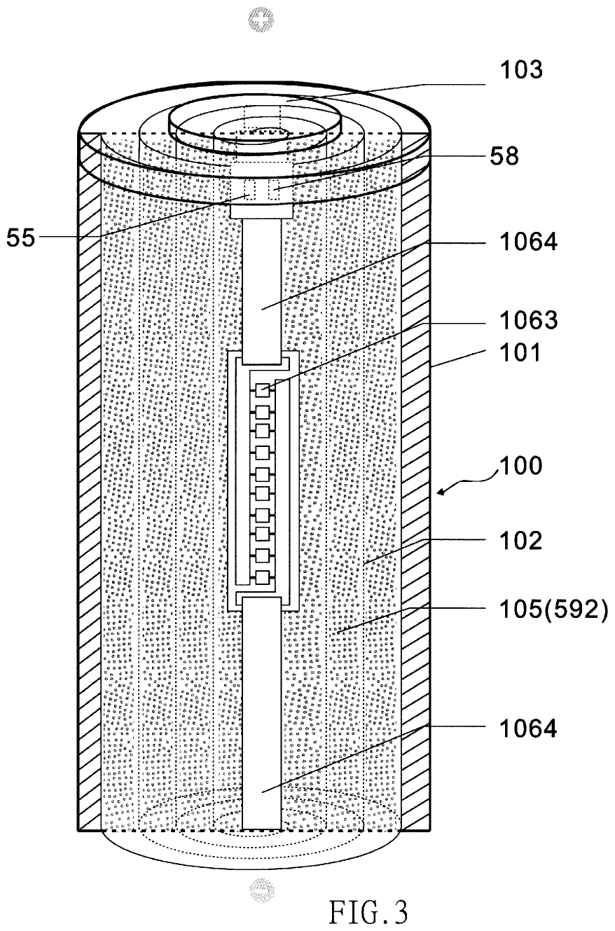

Please refer to FIG. 3 which is a schematic view illustrating the lithium ion secondary battery according to another preferred embodiment of the present invention. According to this embodiment, a current limiting IC 55 electrically connected between the positive electrode terminal 103 and the super capacitor substrate 106 and a Bluetooth communication module 58 capable of communicating with an external power management system (not shown in figures) are further provided. With the Bluetooth communication module 58, the current limiting IC 55 is controlled for limiting an output voltage and an output current of the battery at a desired value, so that when a plurality of the batteries are connected in series and/or in parallel, the output voltage and the output current of each battery can be the same, thereby achieving an optimal charging/discharging effect. In other words, according to the Ohm's law (V/I=R), wherein the V is a voltage, the I is a current and the R is a resistance, when the output voltage and the output current of each said battery are regulated to be same, each said battery will have a same internal resistance, so that, when a plurality of the batteries having said same internal resistance are connected in series and/or parallel to form a module, a yield of the module can be increased. What shall be addressed is that because a RLC resonance is formed by the capacitor 1063 of the super capacitor substrate 106 and the internal resistance R and an inductor L, the service life of the battery can be prolonged and the formation of lithium dendrites can be prevented.

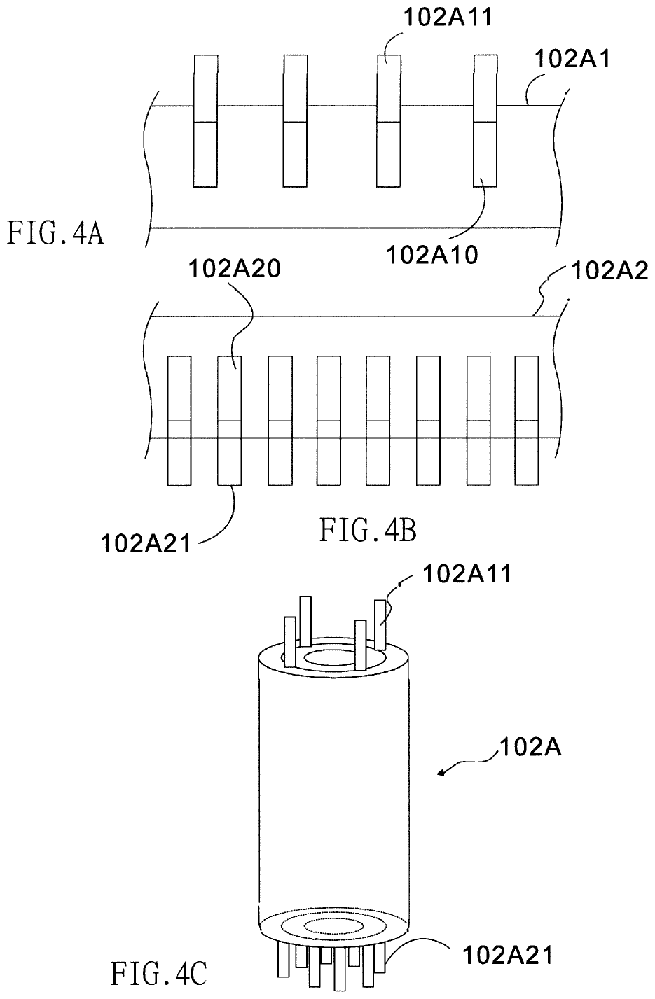

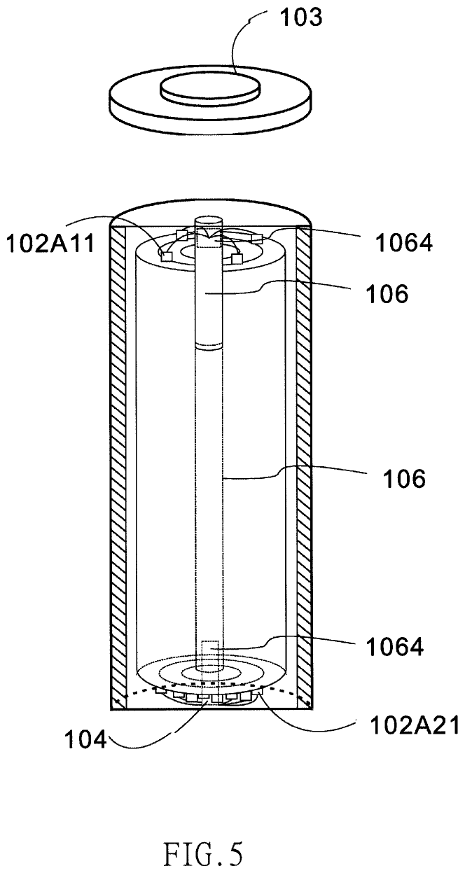

Please refer from FIG. 4A to FIG. 4C, which are schematic views illustrating an electrode set 102A of the lithium ion secondary battery according to one another preferred embodiment of the present invention. As shown from FIG. 4A and FIG. 4B, according to this embodiment, the electrode set 102A has a plurality of first aluminum ear tags 102A11 formed on a first aluminum foil 102A1 having a surface coated with a positive electrode material (shown in FIG. 4A), and a plurality of second aluminum ear tags 102A21 formed on a second aluminum foil 102A2 having a surface coated with a negative electrode material (shown in FIG. 4B), the plurality of first aluminum ear tags 102A11 are formed by putting U shaped cuts on the first aluminum foil 102A1 and then folding cut strips over the first aluminum foil 102A1 and therefore form a plurality of elongated penetrated holes 102A10, the plurality of second aluminum ear tags 102A21 are formed by putting U shaped cuts on the second aluminum foil 102A2 and then folding cut strips over the second aluminum foil 102A2 and therefore form a plurality of elongated penetrated holes 102A20. When the first aluminum foil 102A1 coated with the positive electrode material and the second aluminum foil 102A2 coated with the negative electrode material are rolled, the appearance shown in FIG. 4C is formed. Please refer to FIG. 5, the plurality of first aluminum ear tags 102A11 and the metal sheet (the first metal sheet) 1064 of the super capacitor substrate 106 are both electrically connected to the positive electrode terminal 103, and the plurality of second aluminum ear tags 102A21 and the another metal sheet (the second metal sheet) 1064 of the super capacitor substrate 106 are both connected to the negative electrode terminal 104. With the structure of the first aluminum foil 102A1 and that of the second aluminum foil 102A2, the total current is Iₜₒₜₐₗ=I₁+I₂+Iₙ₊₁, thereby achieving a function of rapidly charging and discharging current.

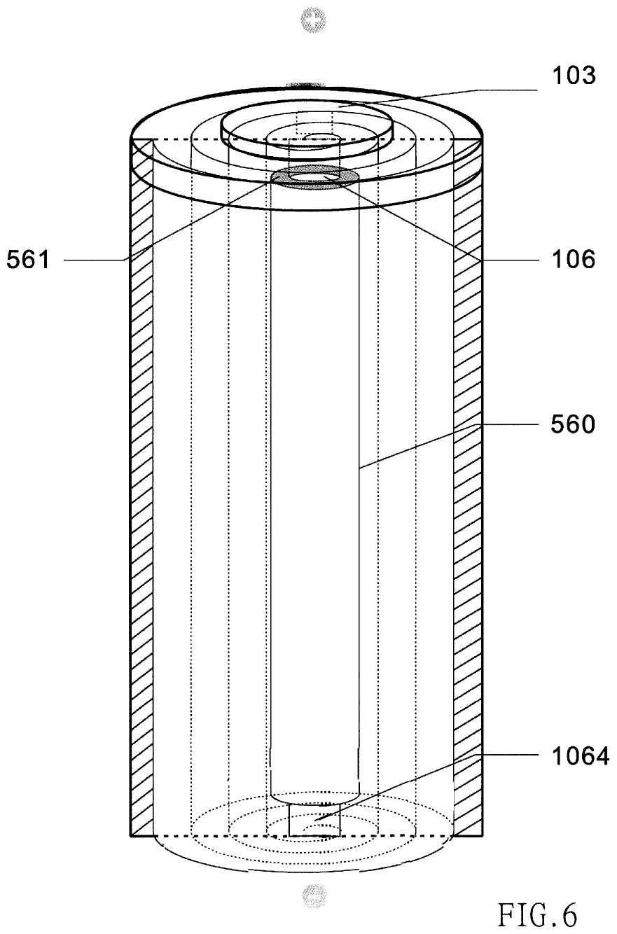

Please refer to FIG. 6, which is a schematic view illustrating the lithium ion secondary battery according to still one another preferred embodiment of the present invention. According to this embodiment, a fireproof and explosion-proof device 56 is further provided. The fireproof and explosion-proof device 56 includes a tubular housing 560 disposed at the center of the secondary battery and a fireproof and explosion-proof agent 561 disposed inside the tubular housing 560. The housing 560 is made of a proper material for allowing the fireproof and explosion-proof agent 561 to flow out while the housing 560 being applied with an impact having a certain strength so as to be broken. The fireproof and explosion-proof agent 561 is consisted of a proper amount of water being mixed with ammonium chloride, sodium bicarbonate, potassium carbonate, diammonium hydrogen phosphate and sodium tungstate. A proportion of the ammonium chloride is 1% to 99% in weight ratio, and the best proportion is 43% to 49% in weight ratio. A proportion of the sodium bicarbonate is 1% to 99% in weight ratio, and the best proportion is 3% to 9% in weight ratio. A proportion of the potassium carbonate is 1% to 99% in weight ratio, and the best proportion is 23% to 37% in weight ratio. A proportion of the diammonium hydrogen phosphate is 1% to 99% in weight ratio, and the best proportion is 6% to 16% in weight ratio. A proportion of the sodium tungstate is 1% to 99% in weight ratio, and the best proportion is 1% to 8% in weight ratio. When the battery is subjected to an impact having a certain strength or is thrust, the housing 560 is broken and meanwhile the fireproof and explosion-proof agent 561 is decomposed and diffused, so that situations of the battery being on fire and/or exploding can be prevented.

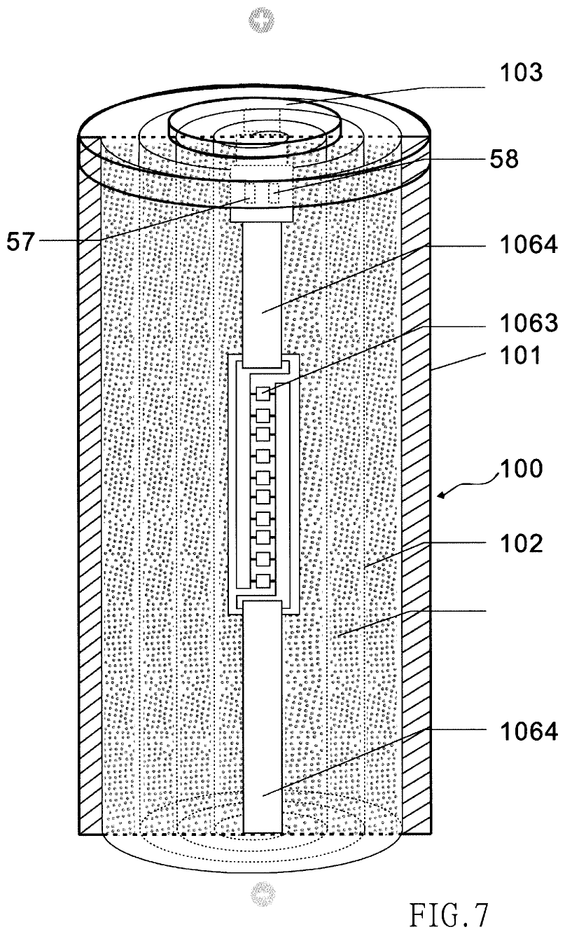

Please refer to FIG. 7, which is a schematic view illustrating the lithium ion secondary battery according to still one another preferred embodiment of the present invention. According to this embodiment, a temperature sensing IC 57 and a Bluetooth communication module 58 are further provided. When the temperature of the battery is abnormally raised, the temperature sensing IC 57 is served to inform the power management system via the Bluetooth communication module 58 to isolate the battery with the abnormally-high temperature, so that situations of the temperature of the battery being continuously raised and occurrences of dangers can be prevented. If the abnormal status is detected more than three consecutive times, the power management system is served to permanently let a battery group to be in an opened loop status for avoiding dangers.

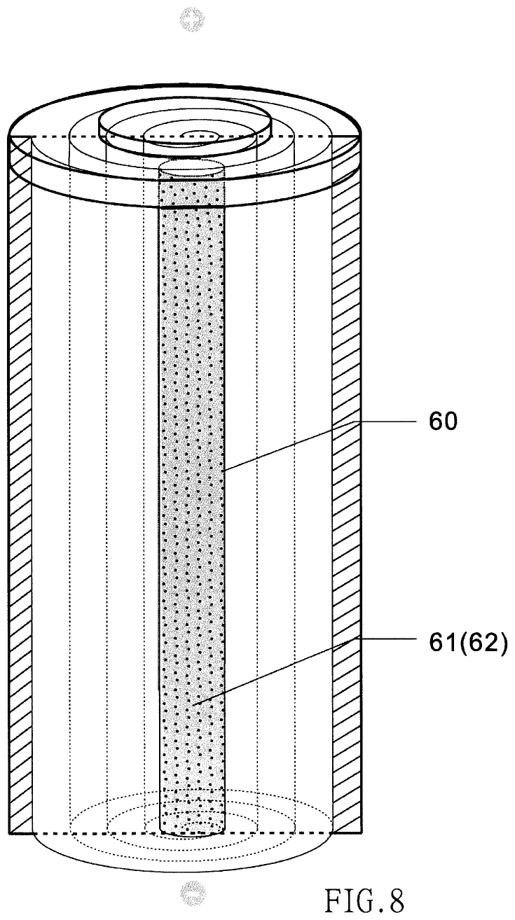

What shall be addressed is that: in a conventional battery, when the battery has been used for a period of time, the amount of electrolyte is decreased which causes the battery to have a shorter service life and the energy density to be lowered or even damaged. Please refer to FIG. 8, which is a schematic view illustrating the lithium ion secondary battery according to still one another preferred embodiment of the present invention. As shown in FIG. 8, the lithium ion secondary battery provided by the present invention further includes a hollow tube 60 disposed at the center of the battery and a polymer material 61 fully absorbing the electrolyte. As such, when the battery has been used for a period of time and the amount of electrolyte has decreased, the electrolyte absorbed by the polymer material 61 is released from the polymer material 61 for automatically replenishing the electrolyte, so that the service life of the battery can be prolonged and the energy density can be maintained. Wherein, a range defined for automatically replenishing the electrolyte is within 1 ml to 100 ml.

What shall be addressed is that: for replacing the electrolyte, liquid, solid and/or gaseous metal filaments or particles 62 can be provided in the hollow tube 60, when the battery has been used for a period of time, the lithium ions are consumed which causes the service life of the battery to be shorter and the energy density to be lower, at this moment, the liquid, solid and/or gaseous lithium material 62 disposed in the hollow tube 60 can be used for automatically replenishing and balancing the amount of lithium ions in the battery, so that objectives of prolonging the service life of the battery and maintaining the energy density can be achieved, and the charging circles of the lithium battery can also be increased.

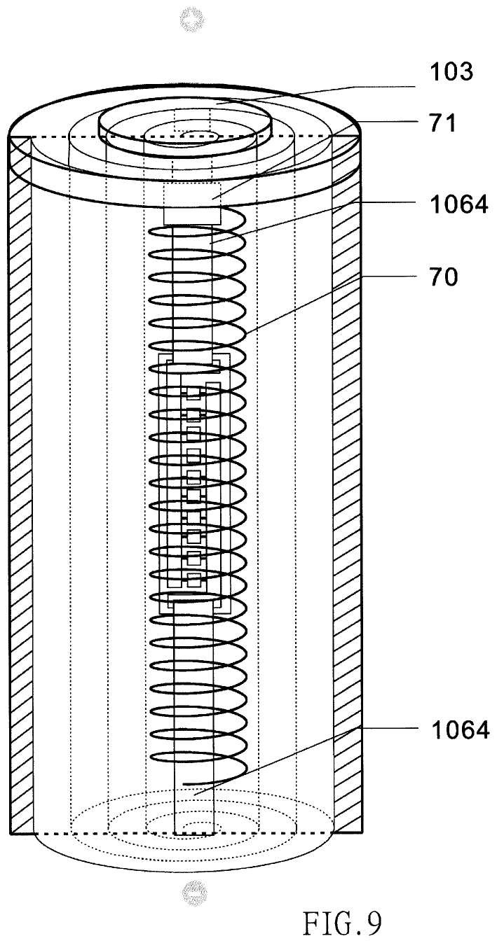

Please refer to FIG. 9, which is a schematic view illustrating the lithium ion secondary battery according to still one another preferred embodiment of the present invention. According to this embodiment, a wireless charging coil 70 and a wireless charging control circuit 71 disposed at the center of the secondary battery are further provided. With the wireless charging coil 70 and the wireless charging control circuit 71, the secondary battery is able to be charged with a wireless means.

What shall be addressed is that: a surface of the round metal column of the columnar lithium or nickel battery (for example a 18650, 22650, 21750 or 44650 battery) being coated with a graphite heat dissipating gel for lowering the temperature changes of the columnar metal battery is one of the features of the present invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A lithium ion secondary battery, including a battery casing, an electrode set reeled inside said battery casing and having a positive electrode and a negative electrode, a positive electrode terminal exposed from a top end of said battery casing and electrically connected to said positive electrode of said electrode set, and a negative electrode terminal located at a bottom end of said battery casing and electrically connected to said negative electrode of said electrode set, said lithium ion secondary battery further including:
a super capacitor substrate, disposed in said battery casing and extended between two distal ends of said battery casing, and including a substrate, a first copper foil electrically connected to said positive electrode terminal of said battery via a first metal sheet, a second copper foil electrically connected to said negative electrode terminal of said battery via a second metal sheet, and at least one capacitor electrically connected to said first copper foil and said second copper foil; and
an electrolyte, suitable to be applied in said lithium ion secondary battery;
wherein with said super capacitor substrate, said battery is protected from being damaged by a reflux current/voltage and a power factor of a load can be increased when the battery is driving the load, and when said battery is used for charging/discharging, said at least one capacitor will perform a micro charging/discharging operation in a high speed on a surface of said positive electrode and a surface of said negative electrode, so as to prevent formation of lithium dendrites, and prevent a reflux situation of said battery, and thereby prolong a service life of said battery.

2. The lithium ion secondary battery as claimed in claim 1, wherein said electrolyte is a lithium salt mixed agent, or a solid-state electrolyte including a polymer electrolyte, said electrolyte has sodium chloride with a weight ratio from 1% to 99%, so that when said secondary battery is used in an environment under zero degree Celsius, said electrolyte is prevented from being frozen so as to ensure a normal operating status of said battery, and said battery is also protected from exploding and burning while being thrust.

3. The lithium ion secondary battery as claimed in claim 1, further including an anti-freezing material containing organic or inorganic nano carbon tetrafluoride, added in said electrolyte and capable of preventing water molecules to be crystalized, thereby preventing an freezing effect from generating for keeping said electrolyte to be in a liquid status, so that said battery is able to be used in an embodiment of minus 60 degrees Celsius and has at least 60% of an original capacity.

4. The lithium ion secondary battery as claimed in claim 1, further including a current limiting IC electrically connected between said positive electrode terminal and said super capacitor substrate, and a Bluetooth communication module capable of communicating with an external power management system; with said Bluetooth communication module, said current limiting IC is controlled for limiting an output voltage and an output current of said battery at a desired value, so that when a plurality of said batteries are connected in series and/or in parallel, said output voltage and said output current of each of said batteries are the same, thereby achieving an optimal charging/discharging effect; according to the Ohm's law (V/I=R), wherein said V is a voltage, said I is a current and said R is a resistance, when the output voltage and the output current of each said battery are regulated to be same, each said battery will have a same internal resistance, so that, when a plurality of the batteries having said same internal resistance are connected in series and/or parallel to form a module, a yield of the module can be increased; moreover, because a RLC resonance is formed by said at least one capacitor of said super capacitor substrate and said internal resistance R and an inductor L, a service life of said battery is prolonged and said formation of lithium dendrites can be prevented.

5. The lithium ion secondary battery as claimed in claim 1, wherein said electrode set has a plurality of first aluminum ear tags formed on a first aluminum foil having a surface coated with a positive electrode material, and a plurality of second aluminum ear tags formed on a second aluminum foil having a surface coated with a negative electrode material, the first aluminum foil being in a rolled state and said plurality of first aluminum ear tags being electrically connected with said positive electrode terminal, which is electrically connected with the first metal sheet of said super capacitor substrate, the second aluminum foil being in a rolled state and said plurality of second aluminum ear tags being electrically connected with said negative electrode terminal, which is electrically connected with the second metal sheet of said super capacitor substrate, the plurality of first aluminum ear tags being formed by putting U shaped cuts on the first aluminum foil and then folding cut strips over the first aluminum foil, the plurality of second aluminum ear tags being formed by putting U shaped cuts on the second aluminum foil and then folding cut strips over the second aluminum foil, and with a structure of aluminum ear tags, a total current is Iₜₒₜₐₗ=I₁+I₂+ . . . +Iₙ₊₁, thereby achieving a function of rapidly charging and discharging current.

6. The lithium ion secondary battery as claimed in claim 1, further including a fireproof and explosion-proof device, said fireproof and explosion-proof device includes a tubular housing disposed at a center of said secondary battery and a fireproof and explosion-proof agent disposed in a tube chamber formed inside said tubular housing, said housing is made of a proper material for allowing said fireproof and explosion-proof agent disposed in said tube chamber to flow out while said housing being applied with an impact having a certain strength so as to be broken; said fireproof and explosion-proof agent is consisted of a proper amount of water being mixed with ammonium chloride, sodium bicarbonate, potassium carbonate, diammonium hydrogen phosphate and sodium tungstate; a proportion of said ammonium chloride is 1% to 99% in weight ratio, and a best proportion is 43% to 49% in weight ratio; a proportion of said sodium bicarbonate is 1% to 99% in weight ratio, and said a proportion is 3% to 9% in weight ratio; a proportion of said potassium carbonate is 1% to 99% in weight ratio, and a best proportion is 23% to 37% in weight ratio; a proportion of said diammonium hydrogen phosphate is 1% to 99% in weight ratio, and said a proportion is 6% to 16% in weight ratio; a proportion of said sodium tungstate is 1% to 99% in weight ratio, and a best proportion is 1% to 8% in weight ratio; when said battery is subjected to said impact having said certain strength or is thrust, said housing is broken and meanwhile said fireproof and explosion-proof agent is decomposed and diffused, so that situations of said battery being on fire and/or exploding are prevented.

7. The lithium ion secondary battery as claimed in claim 1, furthering including a temperature sensing IC disposed between said positive electrode terminal and said super capacitor substrate, and a Bluetooth communication module; when a temperature of said battery is abnormally raised, said temperature sensing IC is served to inform an external power management system via said Bluetooth communication module to isolate said battery with said abnormally-high temperature, so that situations of said temperature of said battery being continuously raised and occurrences of dangers are prevented; if said abnormal status is detected more than three consecutive times, said external power management system is served to permanently let a battery group to be in an opened loop status for avoiding dangers.

8. A lithium ion secondary battery, including a battery casing, an electrode set reeled inside said battery casing and having a positive electrode and a negative electrode, a positive electrode terminal exposed from a top end of said battery casing and electrically connected to said positive electrode of said electrode set, and a negative electrode terminal located at a bottom end of said battery casing and electrically connected to said negative electrode of said electrode set, said lithium ion secondary battery further including:
a hollow tube, disposed in said battery casing and extended between two distal ends of said battery casing, and a polymer material disposed in said hollow tube and fully absorbing an electrolyte; wherein when said battery has been used for a period of time and said electrolyte of said battery has consumed and decreased, said electrolyte absorbed by said polymer material is released from said polymer material for automatically replenishing said electrolyte, so that a service life of said battery is prolonged and an energy density is able to be maintained; wherein, a range defined for automatically replenishing said electrolyte is within 1 ml to 100 ml.

9. A lithium ion secondary battery, including a battery casing, an electrode set reeled inside said battery casing and having a positive electrode and a negative electrode, a positive electrode terminal exposed from a top end of said battery casing and electrically connected to said positive electrode of said electrode set, and a negative electrode terminal located at a bottom end of said battery casing and electrically connected to said negative electrode of said electrode set, said lithium ion secondary battery further including:
a hollow tube, disposed in said battery casing and extended between two distal ends of said battery casing, and liquid, solid and/or gaseous metal filaments or particles disposed in said hollow tube, when said battery has been used for a period of time, lithium ions are consumed which causes a service life of said battery to be shorter and an energy density to be lower, at this moment, liquid, solid and/or gaseous lithium material disposed in said hollow tube is used for automatically replenishing and balancing said lithium ions in said battery, so that objectives of prolonging a service life of said battery and maintaining an energy density are achieved, and charging circles of said lithium battery is able to be increased.

10. The lithium ion secondary battery as claimed in claim 1, further including a wireless charging coil and a wireless charging control circuit disposed at a center of said secondary battery; with said wireless charging coil and said wireless charging control circuit, said secondary battery is able to be charged with a wireless means.
